(19) United States
(12) Patent Application Publication
(10) Pub. No.: US 2023/0289867 A1
(43) Pub. Date: Sep. 14, 2023

(54) DIGITAL SWAG PLATFORM FOR DYNAMIC REDEMPTION

(71) Applicant: Loop Commerce, Inc., Stamford, CT (US)

(72) Inventors: Gabriel Saunkeah, Berkeley, CA (US); Shane Parrish, Menlo Park, CA (US); John Grech, Menlo Park, CA (US)

(21) Appl. No.: 18/159,116

(22) Filed: Jan. 25, 2023

Related U.S. Application Data
(60) Provisional application No. 63/302,673, filed on Jan. 25, 2022.

(51) Int. Cl. G06Q 30/0601

(52) U.S. Cl. CPC G06Q 30/0641

(57) ABSTRACT

Systems and methods for dynamic redemption are provided. A redemption request associated with an online gifting platform may be received, and one or more conditions applicable to the redemption request may be dynamically determined in real-time. Further, a plurality of gifting entities may be dynamically determined to be associated with the applicable conditions in real-time. A menu display of options corresponding to the plurality of gifting entities may be dynamically generated. A selection regarding one of the displayed options may be received, and portions of the selected option may be allocated across the plurality of gifting entities. Data regarding the selected option and one or more of the allocated portions may be routed to the plurality of gifting entities.

### CROSS REFERENCE TO RELATED APPLICATIONS

The present Application claims priority to U.S. Provisional Application 63/302,673 filed on Jan. 25, 2022, which is incorporated herein by reference in its entirety.

### FIELD OF THE INVENTION

The present disclosure relates generally to a digital platform for redeeming swag. More specifically, the present disclosure concerns a digital swag platform for dynamic redemption.

### SUMMARY

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Systems and methods for dynamic redemption are provided herein. A redemption request associated with an online gifting platform may be received, and one or more conditions applicable to the redemption request may be dynamically determined in real-time as the redemption request is received. Further, a plurality of gifting entities may be dynamically determined to be associated with the applicable conditions in real-time with receipt with the redemption request. Thus, the redemption process is triggered by the request to determine the real-time availability of gifts and related options and to offer the determined gifts and options to the participating users as their respective requests are being received.

A menu display of options corresponding to the plurality of gifting entities may be dynamically generated. A selection regarding one of the displayed options may be received, and portions of the selected option may be allocated across the plurality of gifting entities. Data regarding the selected option and one or more of the allocated portions may be routed to the plurality of gifting entities.

### BRIEF DESCRIPTION OF THE DRAWINGS

Illustrative embodiments are described in detail below with reference to the following figures.

FIG. 1 illustrates an exemplary network environment in which a system for dynamic redemption of digital swag.

FIG. 2 is a flowchart illustrating an exemplary method for deploying a customized digital platform for dynamic redemption.

FIG. 3A illustrates an exemplary code for launching a digital platform for dynamic redemption.

FIG. 3B illustrates an exemplary hyperlink for launching a digital platform for dynamic redemption.

FIGS. 3C-D illustrate exemplary graphic user interfaces associated with a digital platform for dynamic redemption.

FIG. 4 is a screenshot of an exemplary online storefront associated with a digital platform for dynamic redemption.

FIGS. 5A-F illustrate exemplary graphic user interfaces associated with item presentation and selection within a digital platform for dynamic redemption.

FIGS. 6A-B illustrate exemplary graphic user interfaces associated with item donation within a digital platform for dynamic redemption.

FIG. 7 is a flowchart illustrating an exemplary method for dynamic redemption.

FIG. 8 is a flowchart illustrating an exemplary method for dynamic redemption across multiple gifter systems.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

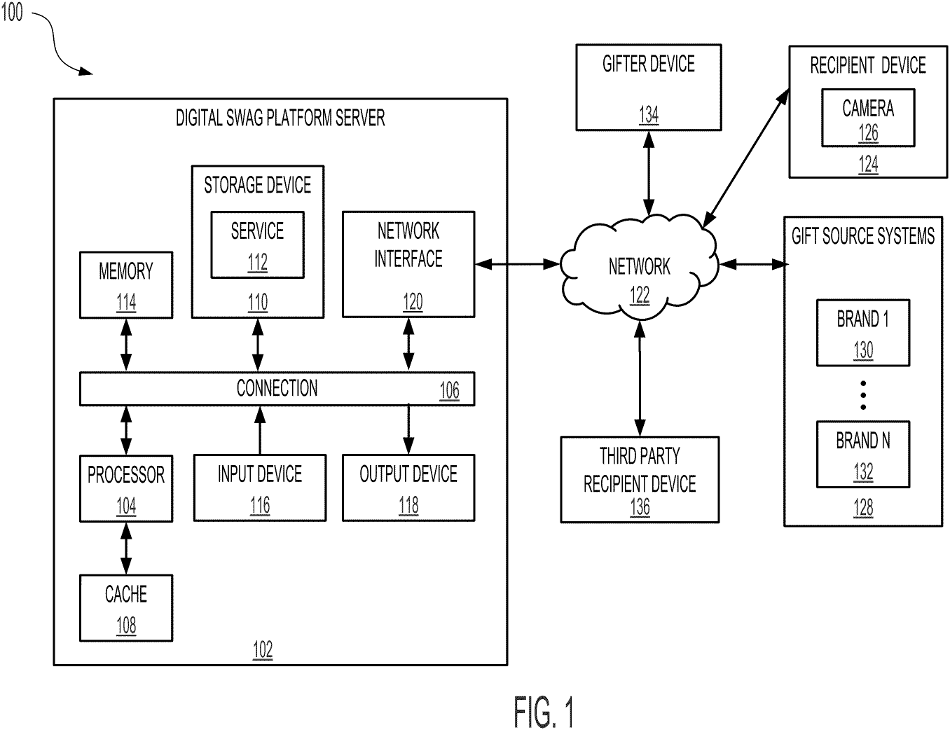

FIG. 1 illustrates an exemplary network environment 100 in which a system for dynamic redemption of digital swag. As illustrated, network environment 100 may correspond to a computing network architecture that includes various component computing devices in electrical communication with each other, in accordance with some embodiments. The computing devices in network environment 100 may communicate with each other using one or more communication networks 122, which may include a local, proprietary network (e.g., an intranet) and/or may be a part of a larger wide-area network. The communications networks 122 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. One or more communications networks 122 allow for communication between the various components of network environment 100. The exemplary network environment 100 illustrated in FIG. 1 includes a digital swag platform server 102, gifter device 134, recipient device 124, gift source systems 128, and third party recipient device 136.

Each of the component computing devices in exemplary network environment 100 described herein may include any type of computing device or server known in the art, including standard hardware computing components such as network and media interfaces, non-transitory computer-readable storage (memory), and processors for executing instructions or accessing information that may be stored in memory. An exemplary computing system architecture and components thereof are described in detail in relation to digital swag platform server 102, but should be also understood as being applicable to the other component devices of exemplary network environment 100. In certain embodiments, functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

The example computing system architecture of digital swag platform server 102 has various components in electrical communication with each other using a connection 106, such as a bus, in accordance with some implementations. The example digital swag platform server 102 may include a processing unit 104 that is in electrical communication with various other system components, using the connection 106, and including memory 114. The memory 114 can include multiple different types of memory with different performance characteristics. In some embodiments, the memory 114 includes read-only memory (ROM), random-access memory (RAM), and other such memory technologies including, but not limited to, those described herein. In some embodiments, the example digital swag platform server 102 may include a cache 108 of high-speed memory connected directly with, in close proximity to, or integrated as part of the processor 104. Data may be read or copied from the memory 114 and/or the storage device 110 to the cache 108 for quick access by the processor 104. In this way, the cache 108 can provide a performance boost that decreases or eliminates processor delays in the processor 104 due to waiting for data. Using modules, methods and services such as those described herein, the processor 104 can be configured to perform various actions. In some embodiments, the cache 108 may include multiple types of cache including, for example, level one (L1) and level two (L2) cache. The memory 114 may be referred to herein as system memory or computer system memory. The memory 114 may include, at various times, elements of an operating system, one or more applications, data associated with the operating system or the one or more applications, or other such data associated with the digital swag platform server 102.

The processor 104 can include any general purpose processor, graphics processor, and other specialized processors for executing instructions (which may further be associated with one or more hardware or software services, such as service 112 stored in storage device 110), where software instructions may be incorporated into the actual processor design. The processor 104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 104 can be a microprocessor, a microcontroller, a digital signal processor (“DSP”), or a combination of these and/or other types of processors. In some embodiments, the processor 104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction, an input device 116 can represent any number and combination of user input mechanisms, such as a microphone for speech, a touch-sensitive screen for gesture or graphical input, keyboard, keypad, mouse, cameras, accelerometers, sensors, motion input tracking devices, stylus/pen, and other such input devices. An output device 118 can also be one or more of a number of output mechanisms known to those of skill in the art including, but not limited to, monitors, projectors, and other display devices, speakers, printers, haptic devices, and other such output devices. In some instances, multimodal systems can enable a user to provide multiple types of input to communicate with the computing system architecture. In some embodiments, the input device 116 and/or the output device 118 can be coupled to the digital swag platform server 102 using a remote connection device such as, for example, a communication interface such as the connection 106 described herein. In such embodiments, the communication interface can govern and manage the input and output received from the attached input device 116 and/or output device 118. As may be contemplated, there is no restriction on operating on any particular hardware arrangement and accordingly the basic features here may easily be substituted for other hardware, software, or firmware arrangements as they are developed.

In some embodiments, the storage device 110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 110 can include hardware and/or software services such as service 112 that can control or configure the processor 104 to perform one or more functions including, but not limited to, the methods, processes, functions, systems, and services described herein in various embodiments. In some embodiments, the hardware or software services can be implemented as modules. As illustrated in example network environment 100, the storage device 110 can be connected to other parts of the digital swag platform server 102 using the network interface 120. In an embodiment, a hardware service or hardware module such as service 112, that performs a function can include a software component stored in a non-transitory computer-readable medium that, in connection with the necessary hardware components, such as the processor 104, connection 106, cache 108, storage device 110, memory 114, input device 116, output device 118, network interface 120, and so forth, can carry out the functions such as those described herein.

The disclosed digital swag platform service and the associated systems and methods for dynamic redemption therefrom can be performed using a computing system such as the example computing system of digital swag platform server 102 illustrated in FIG. 1 in communication with other devices, each of which may include similar computing system components. As discussed in relation to the digital swag platform server 102, an example computing system can include a processor (e.g., a central processing unit) 104, memory 114 including non-volatile memory, and an interface device (e.g., input device 116, output device 118). The memory 114 may store data and/or and one or more code sets, software, scripts, etc. The components of the computer system can be coupled together via a connection 106 (e.g., bus or through some other known or convenient device).

In some embodiments, the processor 104 can be configured to carry out some or all of methods for dynamic redemption described herein by, for example, executing code using a processor such as processor 104 wherein the code is stored in memory such as memory 114 as described herein. One or more of a user device may include gifter device 134, recipient device 124, gift source systems 128, and third party recipient device 136, as well as associated servers or systems, database systems, or other such devices, services, or systems may include some or all of the components of the computing system such as the example computing system illustrated in FIG. 1, using one or more components of the example computing system architecture illustrated herein. As may be contemplated, variations on such systems can be considered as within the scope of the present disclosure.

This disclosure contemplates the computer system of the component computing devices of network environment 100 taking any suitable physical form. As example and not by way of limitation, such computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 114 can be coupled to the processor 104 by, for example, a connector such as connector 106, or a bus. As used herein, a connector or bus such as connector 106 is a communications system that transfers data between components within the digital swag platform server 102 and may, in some embodiments, be used to transfer data between computing devices. The connector 106 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 114 can also include magnetic or optical data storage media including read-only (e.g., CD ROM and DVD ROM) or otherwise (e.g., CD or DVD). The memory can be local, remote, or distributed.

As described herein, the connection 106 (or bus) can also couple the processor 104 to the storage device 110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor 104, memory 114, and a connection 106 (e.g., a bus) coupling the memory 114 to the processor 104.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 106 can also couple the processor 104 to a network interface device such as the network interface 120. The network interface 120 can include one or more of a modem or other such network interfaces including, but not limited to those described herein operable to receive and send communications via communication network 122. It will be appreciated that the network interface 120 may be considered to be part of the digital swag platform server 102 or may be separate from the digital swag platform server 102. The network interface 120 can include one or more of an analog modem, Integrated Services Digital Network (ISDN) modem, cable modem, token ring interface, satellite transmission interface, or other interfaces for coupling a computer system to other computer systems. In some embodiments, the network interface 120 can include one or more input and/or output (I/O) devices. The I/O devices can include, by way of example but not limitation, input devices such as input device 116 and/or output devices such as output device 118. For example, the I/O devices may include a keyboard, a mouse, a printer, a scanner, a display device, and other such components. Other examples of input devices 116 and output devices 118 are described herein. In some embodiments, a network interface device 120 can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the digital swag platform server 102 can be in communication with one or more additional computing devices such as gifter device 134, recipient device 124, gift source systems 128, and third party recipient device 136 via a communication network 122 using a communication interface such as the network interface 120. In some embodiments, a computing device such as gifter device 134, recipient device 124, gift source systems 128, and third party recipient device 136 may include one or more of the types of components as described in connection with digital swag platform server 102 including, but not limited to, a processor such as processor 104, a connection such as connection 106, a cache such as cache 108, a storage device such as storage device 110, memory such as memory 114, an input device such as input device 116, and an output device such as output device 118. In such embodiments, the gifter device 134, recipient device 124, gift source systems 128, and third party recipient device 136 can carry out some or all of the functions such as those described herein in connection with digital swag platform server 102. In some embodiments, the digital swag platform server 102 can be connected to a plurality of computing devices such as gifter device 134, recipient device 124, gift source systems 128, and third party recipient device 136, each of which may also be connected to each other computing device. Such an embodiment may be referred to herein as a distributed computing environment.

The network 122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 122 can be wired connections, wireless connections, or combinations thereof. Communications via the network 122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 122, within the digital swag platform server 102, within the recipient device 124, or within the computing resources provider 128 can include information, which also may be referred to herein as data or content. The information may include text, graphics, audio, video, haptics, and/or any other information that can be provided to a user of the computing device such as the digital swag platform server 102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the digital swag platform server 102 and presented to a user of the digital swag platform server 102 using forms that are perceptible via sight, sound, smell, taste, touch, or other such mechanisms. In some embodiments, communications over the network 122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In exemplary embodiments, gifter device 134 may communicate with digital swag platform server 102 to initiate generation and implementation of system for dynamic gift redemption. For example, an entity associated with gifter device 134 may wish to provide swag (gifts) in association with a real-world or virtual event (e.g., conference, meeting, campaign). Rather than purchasing the gifts beforehand, transporting the gifts to the event venue, staffing gifting stations, or physically handling the gifts, however, the entity associated with gifter device 134 may provide digital swag platform server 102 with gifting conditions and curation input. Based on the provided data, the digital swag platform server 102 may generate a customized digital swag platform that allows for digital access by users, dynamic and individualized evaluation of the gifting conditions in real-time, personalization of selected gift(s), and gift inventory management across one or more gifting source systems 128, as well as coordination and allocation across multiple gifters (entities that wish to contribute toward swag gifts) and recipients. Thus, multiple gifter devices 134 may communicate their respective conditions and curation input to digital swag platform server 102, which may dynamically reconcile such conditions and inputs for each recipient in real-time. Because multiple gifters may contribute towards a single (or a few) gifts for each recipient, the quality of the gifts may be greater than traditional swag individually purchased and given to each recipient. Further, because the recipient has to redeem the gift and is given options for selections and customizations, the recipient is more likely to want the gift and have better brand association with the associated gifters. Moreover, the entire experience of gift curation, selection, customization, and management may take place entirely within a digital context that does not require the physical product to be handled by intervening parties outside of delivery from the gift source to the recipient. Where the redeeming user opts to donate or regift the gift to another party (e.g., associated with third party recipient device 136), the gift may be provided directly to the other party. In such situations where the gift is requested to be provided to another party, the recipient of the gift may never actually handle or otherwise take possession of the gift. Rather, the gift may be sent directly from gift source systems 128 to the other party.

In an exemplary implementation, an entity associated with gifter device 134 may specify gifting conditions for swag or gifts to redeeming users. Such entity may include any entity, company, organization, individual, etc. that may wish to contribute towards a gift. The gifting conditions may include any combination of registration (e.g., with a specific event), authentication, membership, subscription, user profile data, time-based conditions, action-based conditions, availability of certain gifts, other gifter contributions, etc. For example, an entity may specify gifting conditions associated with specific conference, such as conference registration, associated date ranges, and associated conference activities. To qualify for a gift under such conditions, the recipient device 124 may provide a conference identifier, scan a conference badge, attend specific conference meetings, or submit a request within the specified date ranges.

Additional gifting conditions may specify different tiers of gifts, whereby different groups of redeeming users may be provided with different gifting levels. For example, the gifting entity may wish to sponsor different levels of gifting to different types of registered users (e.g., general admission versus more exclusive tiers). The entity may therefore specify the gifting conditions in relation to pre-existing event registration groups or entity-specific groups, such as preferred memberships, subscriptions, or customers. Alternatively or in addition, the entity may specify gifting conditions by user profile data or characteristics. Any combination of parameters may be used to identify which gifting conditions may be applicable to different user groups, including individual user identities.

The gifting conditions may also include dynamic conditions that are determined in real-time for each redemption request. Such dynamic conditions may include time-based conditions, whereby different gifts or contributions towards the gifts may be made available at different time periods. In another example, an entity associated with gifter device 134 may specify that the contribution towards swag gifts may increase or decrease over time to incentivize redemption and/or timing thereof. As a result, the specific gift options provided to a recipient device 124 may vary based on a time of redemption (e.g., when the redemption request is received and/or as the conditions are satisfied). A user of a recipient device 124 that accesses the digital swag platform and initiates a redemption request at one time may be presented with a first set of one or more gift item options, whereas a different user of a different recipient device 124 accessing the digital swag platform and initiates redemption request at a different time may be presented with a different set of one or more gift item options even if the users are satisfy other gifting conditions in common.

Another type of dynamic conditions may be action-based, whereby parameters associated with one or more actions by the recipient may be used to determine whether the entity may contribute towards a gift to the recipient and how much the contribution may be. For example, the action-based conditions may include initiating the request in a particular way, including from a particular code or link, from a particular station within an event venue or otherwise associated with the event, providing certain data (e.g., email address, answers to one or more survey questions), joining a mailing list, adding a subscription, or other actions. In some implementations, the recipient device 124 may be provided with options for performing such actions in order to obtain a different selection of gifts (e.g., higher price points, more customizations). Additional data regarding satisfaction of the gifting conditions may also be dynamically retrieved from the recipient device 124 or other devices in the network environment 100, as well as queried or suggested to the redeeming user via one or more graphic user interfaces. The digital swag platform server 102—whether separately or via a downloaded application—may receive indications confirming performance of the action and automatically update the swag selection of items presented to the recipient device 124.

The entity associated with gifter device 134 may further specify one or more contribution levels associated with the gifting conditions. Such contribution levels may be specified in terms of amounts toward a total cost or portion of the total cost of one or more swag items. Different contribution levels may be specified for different sets of gifting conditions, as well as different swag items. The recipient device 124 may not be presented with the specific contribution levels or amounts associated with the available swag options, however. In such cases, the recipient device 124 may simply be presented with options regarding the available items that correspond to the dynamically determined conditions and applicability thereof, as well as options to qualify for additional items or additional (upgraded) features. For example, the recipient device 124 may be presented not only options for different types of gifts and gift packages based on current status (e.g., bronze level tier), but the recipient device 124 may also be presented with options for changing status (e.g., subscribe, pay, or take another action to move up to silver or gold level tier) and thereby becoming eligible for yet further different gifts and/or contributions thereto. As such, the redeeming user may immediately opt to upgrade their status so as to be presented with further gift options, which may include gifts and gift packages of higher value, rarity or scarcity, more expanded features, or other desired gift options.

Where there are multiple gifting entities whose gifting conditions are met by a redeeming user, each gifting entity may define their respective contribution towards one or more gifts for the redeeming user by specifying a monetary amount or portion of the total cost. The respective contributions of the gifting entities may be combined to identify a total amount that may be redeemed as one or more gifts for the redeeming user. The total amount may be used to filter a set of available gifts (as curated in accordance with curation input from the gifting entities) that may be presented in a graphic user interface for selection.

In implementations where multiple different gifters may contribute towards gifts, such contributions by the multiple different gifters may be combined to identify packages of different combinations of swag items that are available for selection and redemption. In such implementations, another entity (e.g., associated with the event) may communicate with digital swag platform server 102 to set up a platform that can be accessible by multiple gifter devices 134 that each provide their respective gifting conditions, contribution levels, curation input, and other parameters. For a more seamless experience, the entity may further select a set of gift options or gift sources from which the gift options may be provided. Different individual swag items in a package may be sponsored different gifting entities, or the entire package may be collectively sponsored by the set of gifting entities.

Curation input allows an entity associated with gifter device 134 to select one or more gift or swag items towards which the entity contributes. Curation input allows the entity to select which items, products, services, etc., may be associated with their respective brand as part of swag redemption. The curation input may identify different types of products based on different gifting conditions and contribution levels. For example, the gifting entity may identify VIP users or user groups as eligible for different, rarer, or more expensive gifts than other users and user groups. Curation input may also be used exclude certain gifts or categories of gifts so as to avoid brand association with certain products or companies. In some implementation, one or more gift source systems 128 may provide gifts corresponding to different brands 1-N 130-132. The curation input may select one or more gift items provided by gift source systems 128 as being available for redemption through the digital swag platform.

One or more gifting devices 134 may therefore communicate with digital swag platform server 102 to set up a digital swag platform service that provides a digital gift redemption experience in accordance with each gifting entity’s respective conditions, contributions, and input. In some implementations, the digital swag platform service may be specific to an event, in which case another user device associated with the event organizing entity may further provide input as to how the digital swag platform service may operate to coordinate the data from each gifting entity, process redemption requests in real-time, and provide redemption data to the gifting devices 134 and gift source systems 128. Data regarding each gifting entity’s respective conditions, contributions, and input may be stored in memory 114 for later retrieval and analysis in real-time in response to incoming redemption requests by recipient devices 124.

As illustrated, the recipient device 124 may include one or more cameras or imaging sensors 126 that may be used to initiate a redemption request, such as by scanning a QR code or text code (using text recognition). Such a QR code or text code may be provided digitally (e.g., in email, text, multimedia, or other digital message) or physically (e.g., signage, cards, badges, brochures, or other marketing materials). When the recipient device 124 scans or otherwise reads the QR code, the redemption request may be initiated by way of launching an associated website or application specific to the digital swag platform service hosted by the digital gift platform server 102. The website or application may then generate and present a series of graphic user interfaces guiding the user of recipient device 124 through the redemption process.

The real-time conditions that are present when the redemption request is initiated may be determined and used by digital swag platform server 102 in conjunction with the data received from the gifting devices 134 to customize the graphic user interfaces presented to the recipient device. Some conditions may be detected or otherwise provided by the recipient device 124 automatically, some conditions may be determined by the digital swag platform server 102 at the time of the redemption request is received, and yet other conditions may be elicited from the recipient or recipient device 124. Some of the graphic user interfaces presented to the recipient device 124 may be based on the gifting conditions. Such graphic user interfaces may include queries regarding whether the recipient may qualify for one or more of the gifting conditions, suggestions for how to qualify for one or more gifting conditions, and forms for following the suggestions. For example, suggestions may include providing contact or other information, filling out a survey, subscribing to a mailing list, scheduling a call or meeting, or other qualifying actions that meet a gifting condition.

Once the gifting conditions satisfied by the recipient of the recipient device are determined in real-time, digital swag platform server 102 may generate a graphic user interface that presents a menu of gift options available for selection. As discussed above, the gift options may include individual gift items or packages of multiple gift items (e.g., a virtual swag bag). The graphic user interface(s) that present the gift options may further include branding content associated with the gifting entities whose gifting conditions were determined to be satisfied by the recipient. The branding content may be presented by the graphic user interface in association with individual gift items or with the overall package.

The user of recipient device 124 may select from the menu of gift options which gift options to redeem. Each selection may further be customizable by size, color, engraving, embossing, other personalizations, and other features. Such customizations may be selected or otherwise specified via one or more additional graphic user interfaces. Once the selections and customizations may have selected or specified, graphic user interfaces may query for address information where the gifts are to be sent, as well as delivery options. The redeeming user may then specify a preferred mailing address of their own. In some embodiments, however, the redeeming user may opt to specify the mailing address of another individual or organization (e.g., charity) to whom the gift(s) are to be sent. Some implementations further allow the redeeming user to provide an email address to the other individual or organization that may then provide their preferred mailing address. Where an event may have one or more preferred charities, an option may be provided within a graphic user interface to donate the gift to one or more of the preferred charities. The redeeming user may therefore select one or more of the preferred charities to receive one or more of the gift(s) or to receive a donation in an amount of the value of the donated gift(s), which may be provided by way of corresponding physical or digital gift card, stocks, cryptocurrency, other monetary-value adjacent items, or loyalty points or other membership-based value.

The selections by redeeming recipient (via recipient devices 124) may then be provided to gift source systems 128 via the network 122 using a network interface such as those described herein (e.g. network interface 120). In some embodiments, one or more orders based on the selected gift(s) and customizations may further be routed to systems associated with brand 130 and brand 132 for processing. The recipient devices 124 (and/or third party recipient devices 136) may subsequently receive notifications relating to the order(s) and status thereof. The notifications may include branding content associated with the sponsoring gifting entities, or other notifications that include the branding content may be sent to recipient devices 124 (and/or third party recipient devices 136). Such notifications may be generated automatically and sent in accordance with preferences of an event organizer and/or preferences of the specific gifting entities.

Over the course of multiple different events and associated implementations of digital swag platforms, digital swag platform server 102 may track historical data regarding participating gifting entities and their respective gifting data (e.g., gifting conditions, contribution levels, curation input, branding content). In addition, data regarding subsequent engagement with redeeming users may also be tracked and stored in association with the historical gifting data. In some implementations, engagement data may be tracked using customer relationship management (CRM) systems and tools and provided to digital swag platform 102 for further analysis in conjunction with the historical gifting data. Learning models may be developed and continually trained as new deployments occur. Artificial intelligence techniques may be applied to identify patterns and trends among the tracked historical data. Over time, digital swag platform server 102 may use such machine learning models and AI techniques to provide predictions and recommendations to the gifting entities based on real-time events. For example, digital swag platform server 102 may make recommendations to the gifting entities during the process of specifying gifting conditions, contribution levels, and curation input. For example, the digital swag platform server 102 may make suggestions as to gift items that had previously been popular among a similar audience or user groups having similar characteristics in association with prior events and/or digital gifting programs, gift items that led to the higher level of engagement, types of branding content that led to higher levels of engagement, contribution levels that led to broad engagement among the most users, and other insights depending on the particular goals of the gifting entity.

The functions discussed herein may be executed directly by the associated devices or via device execution of one or more services to perform one or more functions under the control of, or on behalf of, programs and/or other services operating on computing device 102 and/or recipient device 124. Systems such as service 130 and service 132 may include one or more computing devices such as those described herein to execute computer code to perform the one or more functions under the control of, or on behalf of, programs and/or services operating on digital swag platform server 102 and/or recipient device 124.

For example, the computing resources provider 128 may provide a service, operating on service 130 to store data for the digital swag platform server 102 when, for example, the amount of data that the digital swag platform server 102 exceeds the capacity of storage device 110. In another example, the computing resources provider 128 may provide a service to first instantiate a virtual machine (VM) on service 132, use that VM to access the data stored on service 132, perform one or more operations on that data, and provide a result of those one or more operations to the digital swag platform server 102. Such operations (e.g., data storage and VM instantiation) may be referred to herein as operating “in the cloud,” “within a cloud computing environment,” or “within a hosted virtual machine environment,” and the computing resources provider 128 may also be referred to herein as “the cloud.” Examples of such computing resources providers include, but are not limited to Amazon® Web Services (AWS®), Microsoft’s Azure®, IBM Cloud®, Google Cloud®, Oracle Cloud® etc.

Services may include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc. As may be contemplated, the services may be implemented on behalf of, or under the control of, digital swag platform server 102 and/or gift source systems 128. Such implemented versions of various services may involve one or more virtualization techniques so that, for example, it may appear to a user of digital swag platform server 102 that the service is executing on the digital swag platform server 102 when the service is executing via the service. As may also be contemplated, the various services operating within the network environment 100 may be distributed among various systems within the environment as well as partially distributed onto digital swag platform server 102 and gift source systems 128.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the digital swag platform server 102) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

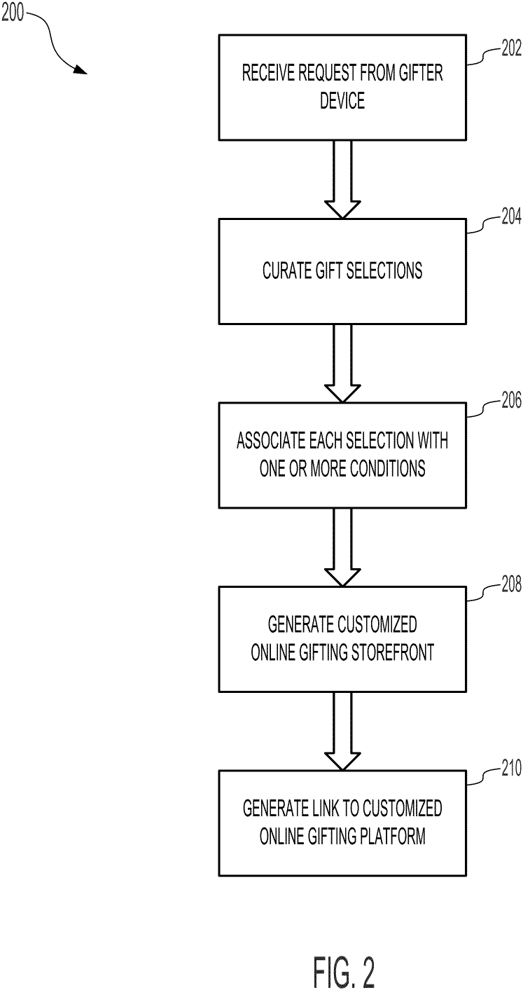

FIG. 2 is a flowchart illustrating an exemplary method 200 for deploying a customized digital platform for dynamic redemption. Such a method 200 may be executed by a digital swag platform server 102 when a request is received by a gifter device 134 (or by a device associated with an event organizer on behalf of multiple gifting entities) to set up and deploy a digital swag platform website or application in step 202. Such a digital swag platform website or application may be customized to generate graphic user interfaces presenting branding content associated with an event, one or more event sponsors, and/or one or more participating gifting entities.

In step 204, the gift selection for the digital swag platform may be curated. Such gift selection may be selected from items available through gift source systems 128 (inclusive of items associated with brands 1-N 130-132). Such gift items may include any product or service that may be provided to a redeeming recipient. The selection of gift items to include in the digital gift platform may be based on curation input from event-associated entities, as well as the participating gifting entities. In some implementations, an event-associated entity may select a set of gift items, and the participating gifting entities may select one or more gift items from the set to sponsor or otherwise contribute towards. Alternatively or in addition, the participating gifting entities may identify a contribution level corresponding to a cost amount (e.g., $10, $25, $50, $100) or corresponding to a cost portion (e.g., 20%, 25%, 50%) of one or more gift items.

Some implementations may include use of the learning models and artificial intelligence techniques to make recommendations as to which gift selections may achieve the particular goals of the gifting entity. The learning models may be based on historical data regarding a plurality of digital gift platform websites and applications associated with different events, gifting entities, gift source systems, and redeeming users. Each interaction involving digital gifting may be tracked as the interaction data is received and used to train the learning models in real-time. Using such learning models, different customer engagement targets and goals may be determined to correlate with certain choices that are made in setting up the parameters of the gifting program, including choice of different gift items or different collections of gift items (e.g., packages or “gift bag”) via curation input. The digital swag platform server 102—whether in association with a website or application—may generate customized graphic user interfaces that include recommended choices for optimizing different goals.

In step 206, the selections may be associated with one or more gifting conditions specified by the gifting entities via gifter devices 134. As discussed herein, the gifting conditions may apply to any parameter regarding the event, the user, the user device, redemption request, gift item(s), cost/status/availability thereof, action(s) desired by the gifting entities, etc. The gifting entity may define their respective contribution level(s) based on which and how many conditions are satisfied by the redeeming recipient. The gifting entity may elect to sponsor different contribution levels, for example, based on whether the redeeming recipient is a VIP guest, whether the redeeming user performs a desired action (e.g., schedules a call or meeting), how many gifts had already been redeemed, and any other combination of conditions. Similar to how learning models and AI techniques may be used to provide recommendations regarding gift item selection, the same may be applied to choice of gifting conditions in order to maximize the changes of achieving certain goals related to branding, user engagement, and/or user satisfaction.

In step 208, a customized online gifting storefront may be generated. Such storefront may correspond to a customized website or customized application (that may be downloadable and launchable by recipient devices 124). The customized website or customized application may be hosted by digital swag platform server 102, which may be configured to generate associated graphic user interfaces based on the event-related and gifting entity-related input received in steps 202-206, as well as responsive to real-time data received at the time of redemption. In some implementations, the customized application may be configured to generate the graphic user interfaces. Digital swag platform server 102 may also update the website or application in real-time, and such updates may be pushed out to devices that have previously downloaded the application. As such, new gifting conditions, gift items, and contribution levels may be provided or updated in real-time.

In step 210, a link to the customized website or customized application may be generated based on a location provided by the digital swag platform server 102 that is hosting the customized website or application. The link may be provided to a recipient device 124, which may then use the link to download and/or launch the customized website and application and initiate a redemption request. The link may be inclusive of one or more hyperlinks, embedded links, uniform resource locators (URL), URL aliases for redirection, and machine-readable or scannable codes such as QR codes.

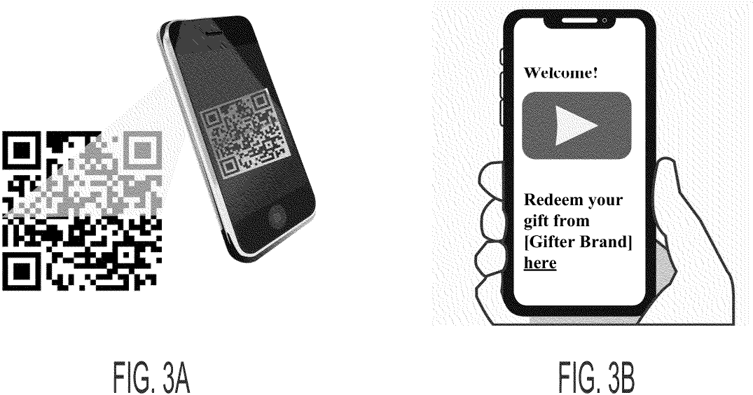

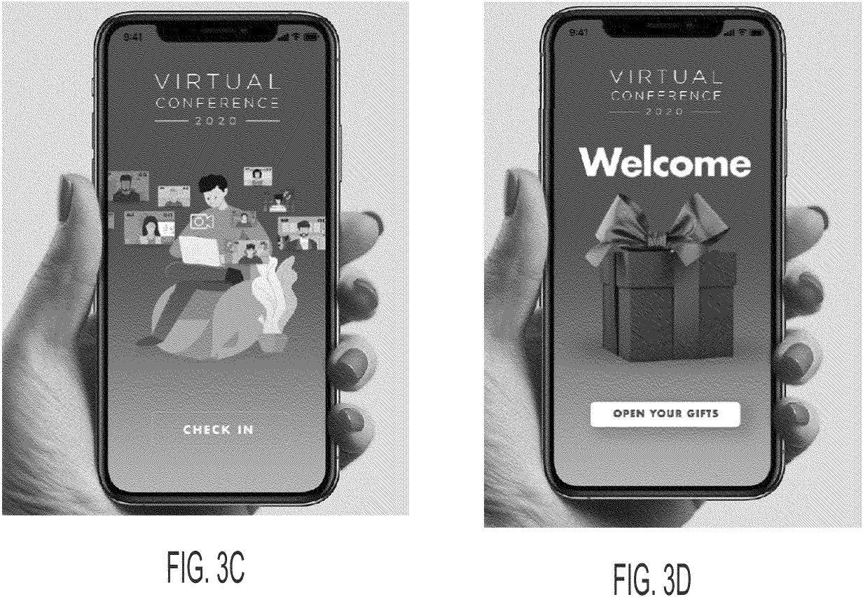

FIG. 3A illustrates an exemplary QR code for launching a digital platform for dynamic redemption. Such a QR code may be displayed or otherwise provided for reading/scanning by a user device (e.g., recipient device 124 using camera 126). For example, signage at one or more physical locations of the event may display the QR code for reading or scanning by attendee devices. Alternatively or in addition, the QR code may be provided on one or more attendee badges, brochures, or other marketing materials. In some implementations, different gifting entities may be provided with different QR codes for redeeming their respective gifts. Thus, redeeming users must physically visit each gifting entity station to scan the QR codes and acquire the ability to redeem different gifting items (or portions thereof) during an event. The QR codes and associated gifts or gift portions (e.g., amounts or percentages applicable to redeem a gift where an accumulation of multiple portions may be required to redeem a gift item) may therefore also incentivize event attendees to visit different physical event locations or interact with different people in order to redeem more gifts or portions thereof, resulting in more valuable gifts or gift packages. Such redemption activities may also be used to provide a gamified experience to the process of redeeming swag gifts.

Upon being read or scanned by the user device, the QR code may be resolved to the link generated in step 210 of the method illustrated by FIG. 2, and that link may be used by the user device to download and/or launch the customized website or application—or specific pages therein—hosted by digital swag platform server 102. Where different QR codes are provided, each link may unlock different gifts or additional gift portions that may be redeemed by a redeeming user of recipient device 124. The redeeming user may redeem the unlocked gift, or use the additional gift portion to upgrade, update, or otherwise modify a previously redeemed gift or set of gifts. As noted herein, redemption may include donating or regifting the gift(s) to another user or organization.

FIG. 3B illustrates an exemplary hyperlink for launching a digital platform for dynamic redemption. The hyperlink may be provided in an email (sent by digital swag platform server 102, an event-affiliated entity, or one of the gifting entities via gifter devices 134) or may be launched in a customized website launched using a QR code. As illustrated, the hyperlink may be embedded in and presented alongside other digital content, including branded content. Such content may include a video, for example, that allows the gifting entity to provide a message to the redeeming user. The hyperlink may be used by recipient device 124 to download and/or launch the customized website or application.

FIGS. 3C-D illustrate exemplary graphic user interfaces associated with a digital platform for dynamic redemption. As illustrated, the graphic user interfaces may be associated with an event-specific mobile application executable on a mobile computing device (e.g., recipient device 124). The graphic user interfaces may include digital content associated with the event, as well as navigation information that guides the user through use of the application and the redemption process. As illustrated in FIG. 3C, the mobile application may include a check-in process whereby the user may check into the event, as well as register the application for use in redeeming gift items. FIG. 3D illustrates a page associated with gift redemption and a button that initiates the gift redemption process.

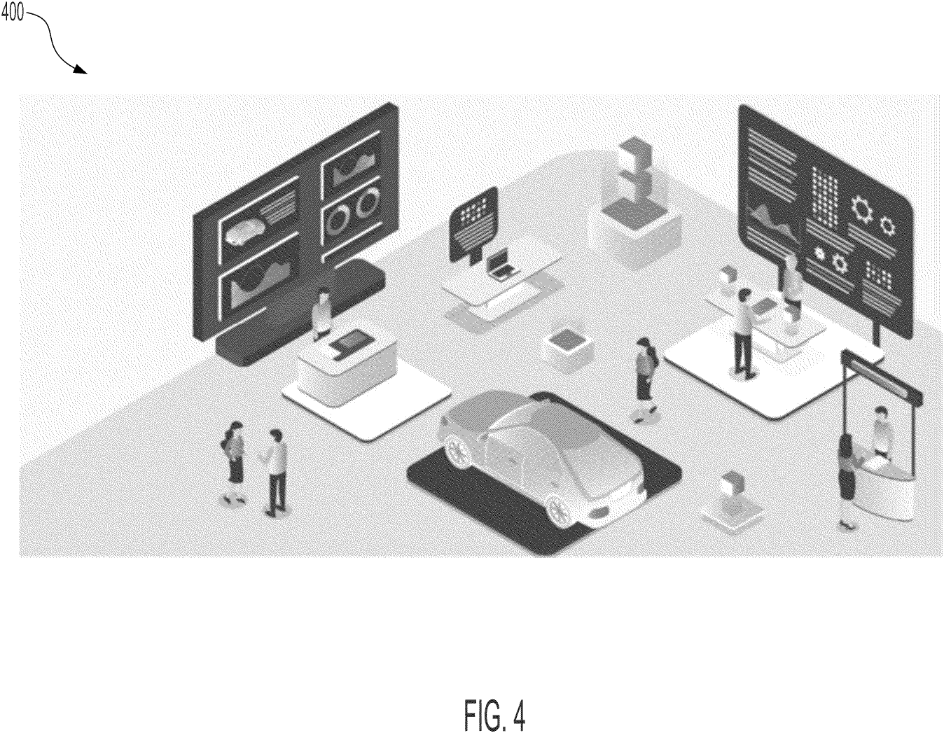

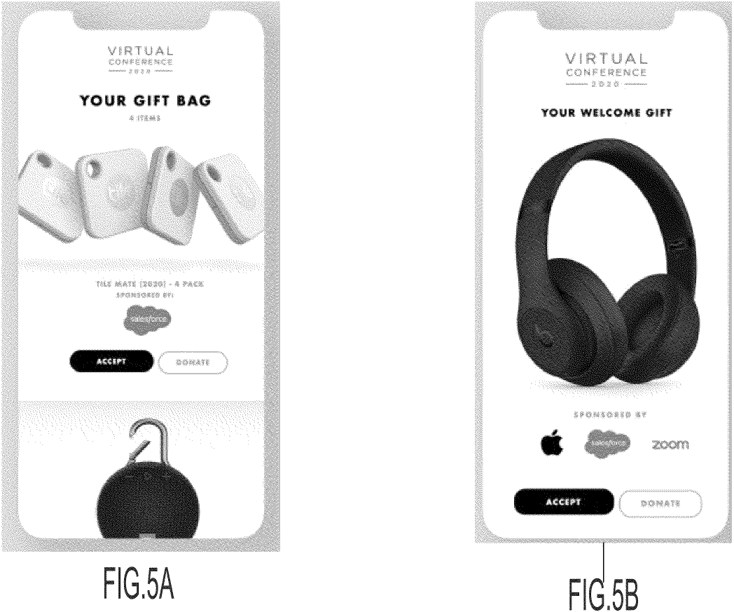

In some implementations, gifts may be redeemed from a virtual storefront generated by a computing device and associated VR accessories. FIG. 4 is a screenshot of an exemplary online storefront associated with a digital platform for dynamic redemption. Within such a storefront, multiple different gifting stations with different gifts may be provided for browsing, demos, selection, and customization. Where an event may be at least partly virtual, one or more virtual gifting stations may be a subset of the virtual stations provided in the virtual environment. A user may therefore enter the virtual environment (e.g., using a recipient device 124 and associated VR accessories) to visit the virtual gifting stations and thereby redeem their gift(s). In exemplary embodiments, the virtual storefront may include interactive elements that allow the user to virtually shop and interact with virtual objects corresponding to available gift options. For example, the VR accessories may include VR googles, projector, or other visual display screen that presents various gift options to the user for selection. Additional VR accessories may include cameras, sensors, etc., that detect physical user gestures and translate them into actions (e.g., turning a virtual object around, zooming in and out to see object details) in relation to the virtual storefront, so that the user may navigate and interact with virtual objects within the virtual storefront.

Entering the virtual storefront and interacting with different virtual gifting stations or objects (e.g., from different sponsors) may itself be used as a parameter in determining the type of gifts available to the user. Each virtual gifting station may further be designed to provide interactive videos, games, and other virtual activities that the user can participate in to win upgrades to available gifts. Rather than having to set up and man a physical kiosk in order to register and qualify long lines of users, therefore, an event sponsor may provide a virtual gifting station that can interact with numerous users at once, each of whom may be engaged in a more interactive and enjoyable experience than at traditional real-world kiosks.

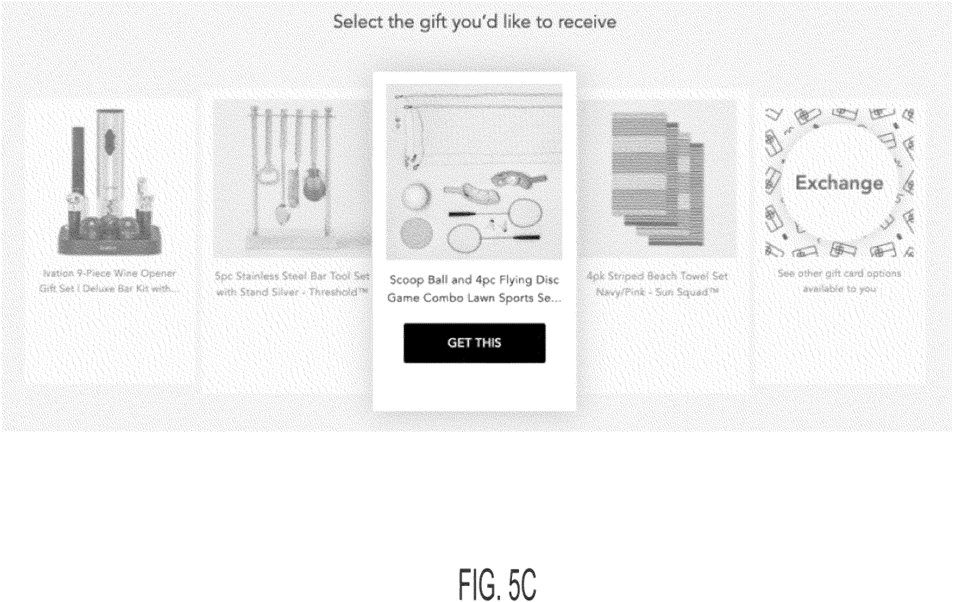

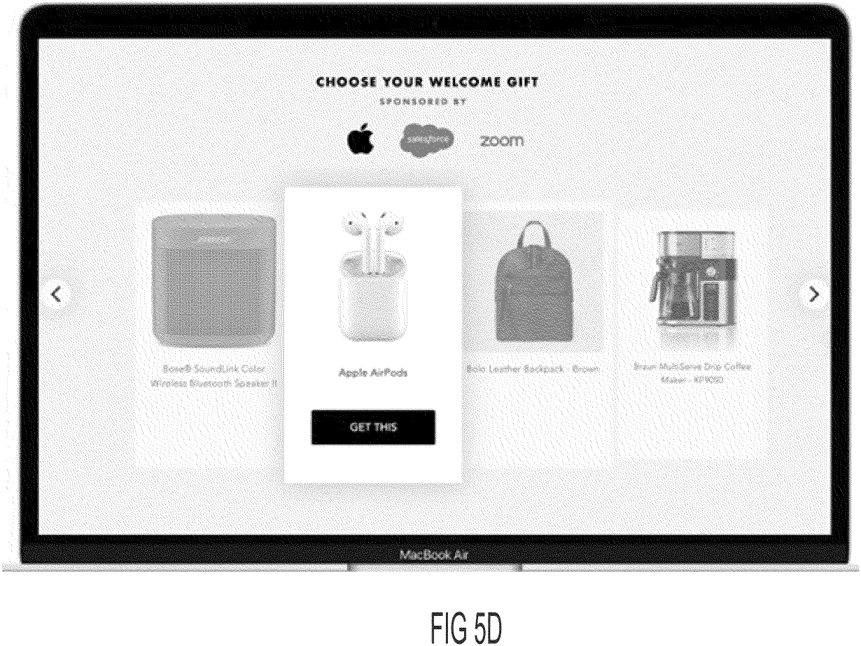

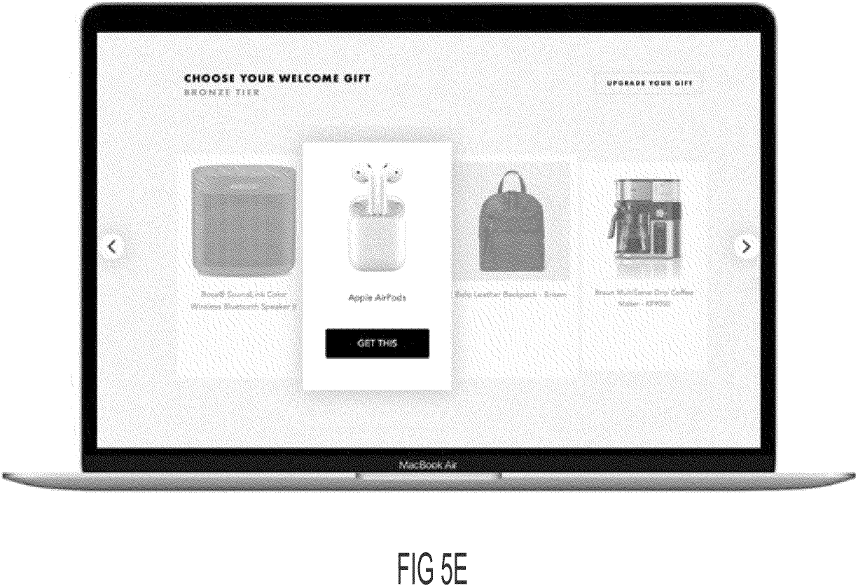

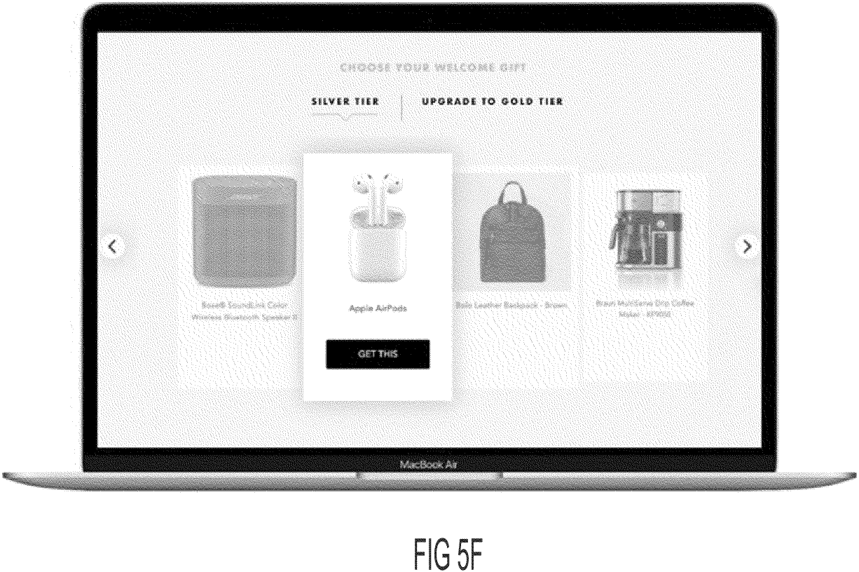

FIGS. 5A-E illustrate exemplary graphic user interfaces associated with item presentation and selection within a digital platform for dynamic redemption. FIG. 5A is a screenshot of an exemplary graphic user interface that provide a specific gift item associated with a single sponsoring or gifting entity. The branding content (e.g., branded logo) may be provided by the gifting entity and presented by the digital swag platform website or application in association with one or more sponsored gifts or gift packages. Such a graphic user interface may be generated and presented to the redeeming user on a display screen of the recipient device when the redeeming user is determined to meet the gifting conditions specified by the gifting entity. Such gifting conditions may be simple (e.g., proof of event registration) or complex (e.g., combination of multiple different conditions). As illustrated, the redeeming user may be given the option to accept the gift or donate the same. Thus, a user who may already possess the gift item or who may not want the gift item may decline gift redemption, which avoids not only waste of the gift item (by gifting an unwanted gift) but also the wasted time and resources to handle inventory related to the same. The associated donation may or may not be a donation of the gift item itself, but may apply to a monetary amount corresponding to the gift item.

Whereas the gift item illustrated in the graphic user interface of FIG. 5A is sponsored by one gifting entity, the graphic user interface of FIG. 5B illustrates a gift item that is sponsored by multiple different gifting entities. Such a graphic user interface may be generated when the redeeming user of recipient device is determined to meet gifting conditions associated with the gifting entities, each of which may contribute a certain portion (e.g., specific monetary amount or percentage of cost) that is cumulatively sufficient to cover the cost of the gift item. The specific portions associated with each gifting entity may or may not be equal, and the respective contribution levels may be used to determine brand placement within the graphic user interface. Like the gift item in the screenshot of FIG. 5A, the gift item illustrated in the screenshot of FIG. 5B may be accepted or donated.

Whereas the screenshots of FIGS. 5A-B presents individual gifts that may be accepted or donated on an individual basis, the screenshot of FIG. 5C illustrates a menu of multiple gift items where one or more selections may be made. Such a graphic user interface illustrated in the screenshot of FIG. 5C may be generated when the redeeming user may be determined to meet gifting conditions specified by one or more gifting entities that may further have curated multiple different gifts towards which their respective contributions may be applied. Where there may be multiple gifting entities, the respective contributions may be accumulated to identify a total amount, which may be identified as sufficient to redeem each of the specific gift items illustrated in the graphic user interface of FIG. 5C.

Similarly, FIG. 5D illustrates a screenshot of a graphic user interface that includes a menu of different gift items sponsored by a specific set of three different gifting entities. Such a graphic user interface may be generated where the three different gifting entities may have agreed to sponsor a third of the cost of each of the gift items displayed for the redeeming user. The redemption request may have initiated a real-time determination that the redeeming user meets the gifting conditions of the gifting entities, as well as qualifies for the displayed gift items and a gift contribution level of a third from each of the gifting entities respectively.

FIG. 5E illustrates a screenshot of a graphic user interface that includes a menu of different gift items that are each individually sponsored by a different gifting entity. As illustrated, the graphic user interface presents each gift item in association with the branded logo of the gifting entity. Such a graphic user interface may be generated where each of the gifting entities may be assigned sponsorship for one specific gift item. In such an implementation, the redeeming user may select a single gift item for redemption from among the menu of gift items presented. Such an arrangement allows the gifting entities to be associated with specific gift items, which may further certain brand associations. Depending on which gift item is selected by the redeeming user, subsequent notifications and communications to the redeeming user may only include branding content associated with the gifting entity that sponsored the selected gift. As illustrated in FIGS. 5E and 5F, the graphic user interface may also include an indication of a current status (e.g., “Bronze Tier,” “Silver Tier”) with an option to upgrade to a higher status (e.g., “Upgrade Your Gift,” “Upgrade to Gold Tier”). The user may therefore elect to proceed with the current status or seek to upgrade the status (and thereby be provided with different, upgraded gift options). Depending on specifications provided by the gifter, upgrading status may entail one or more specified actions. Upon completion of the actions, the user may be provided with access to the upgraded gift options.

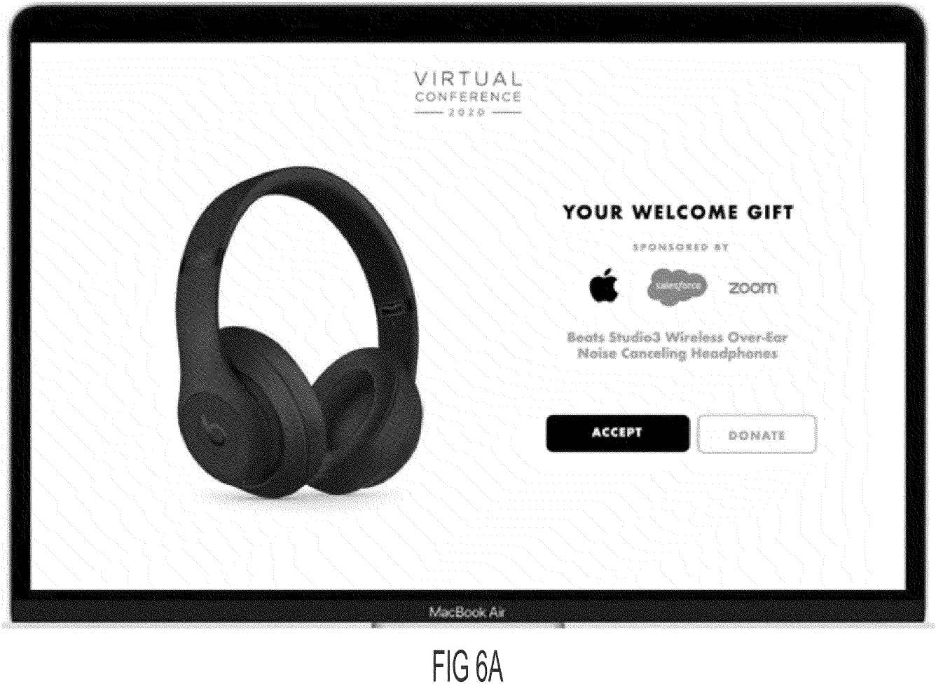

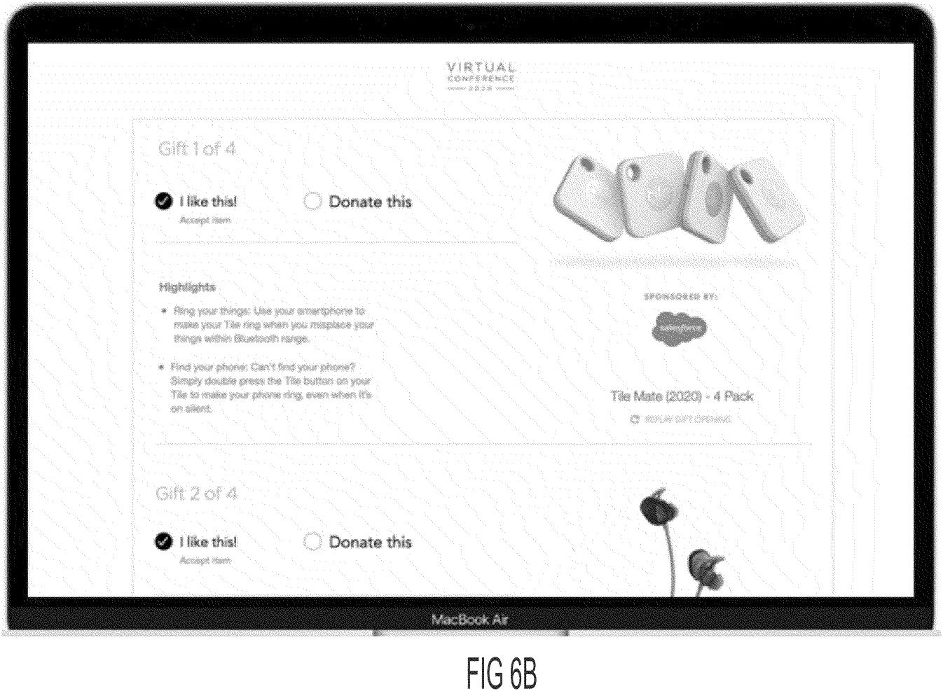

FIGS. 6A-B illustrate exemplary graphic user interfaces associated with item donation within a digital platform for dynamic redemption. FIG. 6A illustrates a screenshot of a graphic user interface presenting an option to donate a single gift item according to one embodiment. As illustrated, the options associated with the gift item include an option to accept and an option to donate. Similarly, FIG. 6B illustrates a screenshot of an alternative graphic user interface that may be generated and presented according to another embodiment. Such a graphic user interface presents a series of donation options for individual gifts among a plurality of gift items for which the redeeming recipient may have qualified.

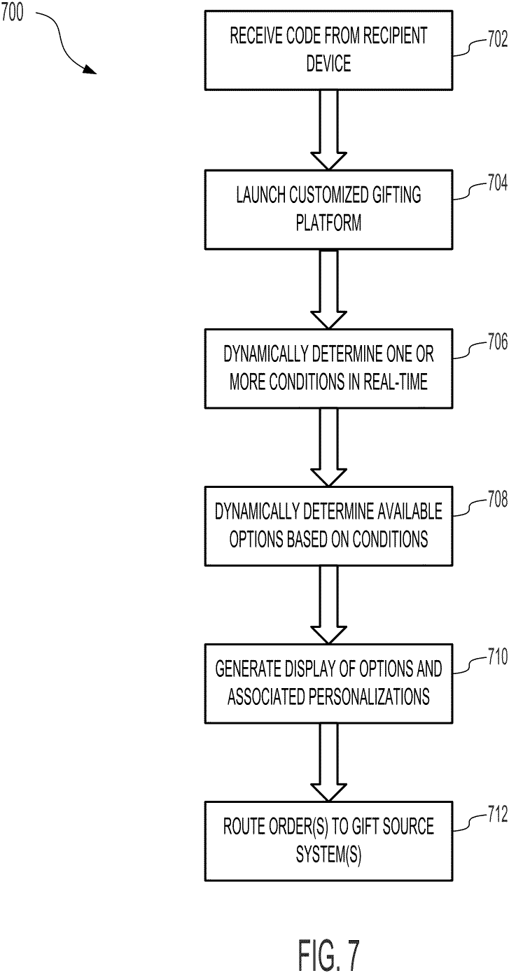

FIG. 7 is a flowchart illustrating an exemplary method 700 for dynamic redemption. Such a method 700 may be executed by digital swag platform server 102 for each redeeming user during an event for which a customized digital swag platform had been configured and deployed in accordance with the method of FIG. 2. Using the customized digital swag platform website or application, method 700 may be performed for each redeeming user, as many times as there are redeeming users. Many of the steps are performed dynamically and in real-time based on conditions that exist at the time of the redemption request by each redeeming user.

In step 702, a code may be received from a recipient device 124 of a redeeming user. The code may be a QR code or link that had been communicated or otherwise provided to the recipient device in association with an event, including in event-related signage, materials, and communications.

In step 704, a customized gifting platform associated with the received code may be launched. As noted herein, the customized gifting platform may correspond to a specific website or downloadable application that may have been generated and deployed in relation to a specific event. Where digital swage platform server 102 may host multiple different gifting platforms (e.g., for different events), the QR code may be used to identify and resolve the specific gifting platform specific to the event associated with the redeeming user. Launching the platform may include downloading digital data associated with the website or mobile application to the recipient device, as well as any updates that may have been made since the customized website or application was deployed. One or more graphic user interfaces may then be presented at the recipient device 124, which may present options for navigating the website or application. At least one option may include an option to request redemption of one or more swag gift items. Because the exact gift items are dynamically determined and selected during the redemption process, it may be unknown as to which gift items are available at the time the option to request gift redemption is selected.

In step 706, one or more conditions associated with the redemption request may be dynamically determined in real-time. Based on the gifting conditions previously specified by the gifting entities and stored in association with the customized gift platform, the digital swag platform server 102—and/or the application downloaded from the same—may analyze any data received from the recipient device 124 during launch and initiation of the redemption request. Depending on whether the recipient device 124 may have previously launched the website or application, registered an account, or provided other data, such registration data may be evaluated in real-time. For example, user data and other registration may be retrieved from the recipient device 124 or digital swag platform server 102 for comparison to the gifting conditions. In addition, data regarding gift item inventory and preferred user groups may be retrieved from gift source systems 128 and gifter devices 134 (if not already provided to digital swag platform server 102) for evaluation of gifting conditions regarding availability and differential treatment of different user groups. In addition, there may be gifting conditions may require further querying or action to determine. The user may be given the option to satisfy such conditions in real-time using one or more graphic user interfaces.

In some instances, the gifting conditions may entail performing specific actions, being at specified locations, meeting with specified individuals or teams, etc. The redeeming user may be given the option to satisfy such gifting conditions, so as to qualify for more or higher-value gift items. Where the redeeming user opts to proceed with such actions, one or more graphic user interfaces may be generated that guide the redeeming user through each action. For example, where the action is providing contact information or scheduling a call or meeting, the graphic user interfaces may request access to calendars or contact information on the recipient device 124. Alternatively, the graphic user interfaces may present a form query for the user of the recipient device 124 to enter such information. Completing the action may satisfy one or more additional gifting conditions associated with gifting entities that have specified additional or larger contributions be associated with satisfaction of the additional gifting conditions.

The redeeming user of recipient device 124 may therefore be dynamically determined to have satisfied a certain set of the gifting conditions in real-time in step 706. The identified set of gifting conditions may be associated with one or more gifting entities, each of which may have further specified a certain amount or portion of one or more gift items to sponsor. For example, the gifting entities may each sponsor a third or a quarter of a certain gift. In step 708, the collective sponsorships—and the cumulative amounts or portions thereof—may be dynamically determined in real-time and used to identify which gift item(s) from among the available gift items are sponsored for the redeeming user. Where individual gifting entities may sponsor individual gifts, the accumulation of satisfied gifting conditions for at least a subset of the gifting entities may correspond to a set of different gift item options. As such, instead of physical swag bags containing the same set of physically-branded (e.g., sponsor name or logo), lower-value items across all attendees of an event, the user of recipient device 124 may be offered higher-value item options that are not physically branded.

In step 710, the identified gift items may be used to generate one or more graphic user interfaces that present the sponsored gift items alongside branding content of the associated gifting entities. The user may either opt to accept such gifts, select a subset of qualifying gifts, exchange for monetary or other exchangeable item, donate any unwanted items (or the value thereof), and/or otherwise decline to accept any unwanted items, thereby reducing waste. Where the user may accept a gift item, the user may further be presented with graphic user interfaces via recipient device 124 that allow for one or more personalization selections. Different gift items may come in a variety of different sizes, colors, and other features that may be personalized to the redeeming user based on one or more selections and specifications. Such selections and specifications may be included in the dynamic determination as to available gift options. Additional graphic user interfaces presenting options or forms for receiving such selections and specifications may be generated and presented to the redeeming user via recipient device 124. Once all selections and specifications have been entered, the redeeming user may further be requested—via one or more graphic user interfaces presented on the recipient device—for delivery information. The redeeming user may further select or otherwise provide input as to how to deliver the redeemed gift items. Some implementations allow for exchanges based on a value of the gift(s) available to the user. Such exchanges may be provided by way of corresponding physical or digital gift cards, stocks, cryptocurrency, other monetary-value adjacent items, or loyalty points or other membership-based value.

In step 712, order(s) associated with the redeeming user may be routed to gift source systems 128 for processing. As noted herein, gift source systems 128 may be associated with different brands 1-N 130-132. Where orders may include multiple items of different brands, different brand-specific systems may be used to process the order. As such, step 712 may include routing the order(s) to the respective systems of the different brands 1-N 130-132. The order(s) for the redeeming user may specify the selected gift item(s), as well as any selections or specifications input by the redeeming user. The order(s) may further include the delivery information, so that the gift item(s) may be delivered to the redeeming user. In some implementations, gift source systems 128 may allow for pickup from physical locations, such as stores, booths, physical gifting locations, or other type of location. Where the redeeming user may have request such an option, the order may also include such selected option. Notwithstanding, the gift source systems 128 may process the order so as to manage personalization and delivery of the selected gift item(s) in accordance with the selections and specifications of the redeeming user.

During steps 702-712, the input by the redeeming user (e.g., various selections and specifications) may be tracked and used to train existing machine learning models. The input by the redeeming user may therefore serve as feedback as to how users are likely to behave in relation to the digital gifting program. Different user traits and different gifting program parameters may be correlated so that future predictions and recommendations may be improved and become more granular as to how to target different user groups more effectively in relation to different goals. In addition, digital swag platform server 102 may further use such learning models to assist event organizers and gifting entities to set up effective gifting programs for their respective events and brands.

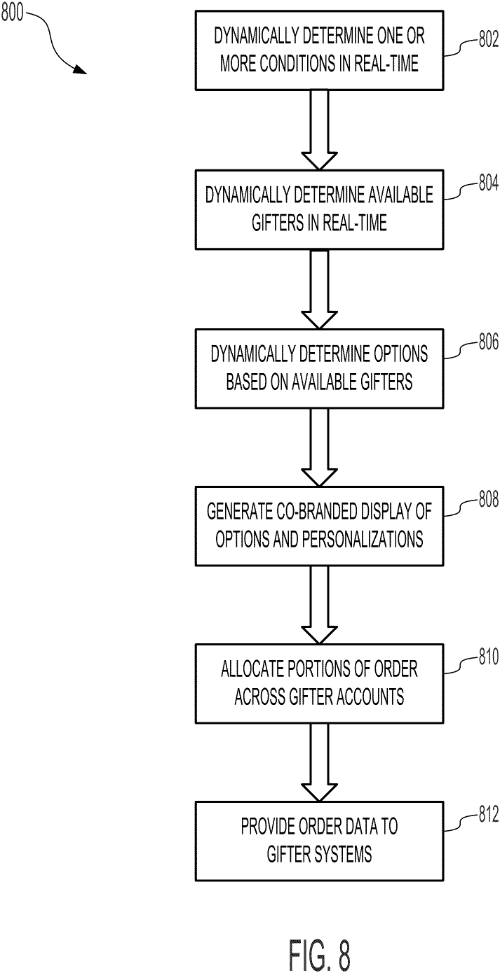

FIG. 8 is a flowchart illustrating an exemplary method 800 for dynamic redemption across multiple gifter systems. Method 800 may represent a more detailed implementation of the method 700 of FIG. 7, specifically as it pertains to interaction with multiple different gifter systems (e.g., gifter devices 134) and combined sponsorships relating to one or more gift items. As such, step 802 may be performed similarly to step 706 so as to determine in real-time one or more conditions that are satisfied by the redeeming user. As discussed herein, different gifting entities may have specified different gifting conditions. Digital swag platform server 102 may evaluate the collective set of gifting conditions associated with the digital swag platform and dynamically determine in real-time that a subset of the gifting conditions are satisfied by the redeeming user in step 802.

In step 804, digital swag platform server 102—or the associated digital swag platform application or website—may dynamically determine which available gifting entities are associated with the subset of satisfied gifting conditions. The data regarding the identified gifting entities may be evaluated to identify available sponsorships or gift contributions for applicable to the redemption request. For example, the identified gifting entities may be associated with respective contribution amounts or portions towards a redeemable gift item or set of items. Because the gifting entities may dynamically update gifting conditions in real-time, the specific set of gifting entities identified in step 804 may vary based on when the redemption request is received. For example, a gifting entity may push out a new promotion whereby additional gifting conditions and associated gift contributions may be made available for redemption for qualifying users. Where the redemption request is deemed to have satisfied such conditions, the gifting entity and their respective contribution may be identified in step 804.

The cumulative contribution amounts or portions of the identified gifting entities may be evaluated in step 806 to determine what gift item(s) (and features and personalizations) may be fully sponsored for the redeeming user. Such determination may be performed dynamically in real-time and may take into account real-time inventory data (e.g., as provided by gift source systems 128). A set or subset of the fully sponsored gift items may be selected for presentation to the redeeming user. In implementations where the digital swag platform may have been provided with preference data or other user data (e.g., products already owned), the gift items may further be filtered and refined to reflect gift items and features most likely to be of interest to the redeeming user. In some embodiments, redemption requests associated with the digital swag platform (and the event) may be tracked in real-time to identify redemption trends and patterns, which may also be used to filter the set of gift items for the redeeming user. Artificial intelligence and learning models may be used in such implementations to track user data and the redemption trends and patterns specific to certain user traits. As such, users associated with certain sets of traits or characteristics may be determined to be more likely to select a certain gift item and/or personalizations. Such insights may be dynamically used in real-time to evaluate the redeeming user and the gift item(s) (and features/personalizations) most likely to be of interest.

In step 808, a branded display may be generated in one or more graphic user interfaces to present the identified set of gift times on the recipient device 124 of the redeeming user. The branding content associated with each of the gifting entities identified in step 804 may be used to generate the branded display. Depending on the specific gifting conditions and contribution levels, each gift item may be visually presented for selection alongside the associated branding content of one or more of the identified gifting entities. As discussed herein, individual gift items may be sponsored by a single entity or may be sponsored by multiple entities. Similarly, packages comprising multiple gift items may be sponsored by one or more gifting entities. As such, the particular placement or prominence of the branding content with a display of a specific gift item may depend on how many gifting entities are associated, as well as the respective contribution levels of each. For example, different gift items may be sponsored by different sets of one or more gifting entities, as well as different contribution levels from each gifting entity. Such details may not necessarily be discernible nor explicitly communicated to the user, however. An exemplary gift item may be sponsored at 50% by a primary gifting entity and at 25% by two secondary gifting entities. The branding content of the primary gifting entity may be larger and/or otherwise more prominent within the branded display than the branding content of the secondary gifting entities.

In step 810, the respective contribution portions of an order may be allocated across the identified gifting entities. Depending on the particular gift item(s) selected and personalization feature(s) selected or specified, different redemption amounts may apply to the overall order. As noted above, different gifting entities may sponsor different amounts or portions depending on the specific gift item (and ultimately the gifting conditions satisfied). The final selections of the gift item(s) and personalization(s) in the order may be evaluated to determine which of the gifting entities are associated, as well as the respective contribution levels of each gifting entity. As discussed extensively herein, the contribution level may be a set amount payable towards the order or a set percentage or fractional portion of the total redemption cost of the order, including associated taxes and shipping/handling fees.

Step 810 therefore allocates portions of the total cost of the order to the sponsoring gifting entities, which may be a subset of the gifting entities identified in step 804. Where the redeeming user may decline certain gift items sponsored a gifting entity, for example, that gifting entity may not be included in the allocation. A similar allocation may apply where the redeeming user may have opted to donate one or more gift items. Depending on the parameters of donation, the gift items themselves (or another corresponding item) may be donated to an identified recipient charitable organization. For example, instead of the gift item itself being donated, the total cost may be used to purchase trees for planting on behalf of an environmental organization or to purchase toys for charities involved in children’s services. Alternatively, monetary gifts corresponding to the total redemption cost may be made to one or more identified charitable organizations. Regardless of the type of redemption, the respective amounts or portions may be calculated and allocated across the gifting entities associated with the order.

In step 812, data regarding the order (including respective allocations) may be provided to the gifter systems (e.g., gifter devices 134). Such data may include an accounting of what gift items were redeemed, who redeemed what gift item(s), redemption options, redemption locations, associated costs, and other data associated with the order. Such data may be provided from digital swag platform server 102 and/or from gift sources systems 128. As such, the gifting entities may be made aware of when and where (e.g., booth at event, store near event) the order deliveries are made, which may also trigger automatic messages that include branded content to be sent to the redeeming users or other devices at the redemption location. The automated messages may further be customized based on the data information regarding the redeeming user(s) and/or redeemed order(s) at the redemption location. While each gifting entity may have different customer engagement plans, data regarding the redeeming users and associated gift redemptions may be used to gauge and calibrate messaging for the redeeming users. A gifting entity may use artificial intelligence techniques and learning models may likewise be used to evaluate the relative success of different gifting plans (e.g., different gifting conditions, curated gift packages, contribution levels) across different events over time. The gifting entity may therefore be able to refine their gifting plan for each future event to optimize the likelihood of redemption and therefore the strength of branding and engagement of preferred users and user groups.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the flowcharts of FIGS. 2, 5, 7). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the digital swag platform server 102.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving a redemption request associated with an online gifting platform;
dynamically determining in real-time one or more conditions applicable to the redemption request;
dynamically determining in real-time a plurality of gifting entities that are associated with the one or more applicable conditions;
dynamically generating a menu display of one or more options corresponding to the plurality of gifting entities;
receiving input corresponding to a selection regarding one of the displayed options;
allocating one or more portions of the selected option across the plurality of gifting entities; and
routing data regarding the selected option and the one or more allocated portions to the plurality of gifting entities.

2. The computer-implemented method of claim 1, wherein the online gifting platform is associated with a set of available gifting entities, and wherein the determined plurality of gifting entities is identified from among the set of available gifting entities.

3. The computer-implemented method of claim 1, wherein the redemption request is associated with a user device, and further comprising:
launching the online gifting platform based on the redemption request, wherein the launched online gifting platform establishes communication with the user device.

4. The computer-implemented method of claim 1, further comprising:
storing data regarding the plurality of gifting entities, the stored data including one or more of the applicable conditions; and
querying a user device associated with the redemption request based on the stored data, wherein dynamically determining the plurality of gifting entities is based on one or more query responses.

5. The computer-implemented method of claim 1, further comprising:
storing branding content associated with the plurality of gifting entities; and
generating one or more graphic user interfaces based on the stored branding content in response to the redemption request.

6. The computer-implemented method of claim 5, wherein different branding content is presented in response to a subsequent redemption request.

7. The computer-implemented method of claim 1, wherein a different menu display of options is dynamically generated in response to a subsequent redemption request.

8. The computer-implemented method of claim 1, wherein different conditions are dynamically determined to be applicable to a subsequent request.

9. The computer-implemented method of claim 1, wherein a different plurality of gifting entities is dynamically determined to be associated with a subsequent request.

10. The computer-implemented method of claim 1, further comprising:
receiving one or more personalization inputs associated with the selected option, wherein one of the personalization inputs identifies a third party recipient; and
generating a notification regarding the selection option, wherein the generated notification is provided to a device associated with the third party recipient.

11. A system comprising:
a communication interface that receives a redemption request associated with an online gifting platform; and
a processor that executes instructions stored in memory, wherein the processor executes the instructions to:
dynamically determine in real-time one or more conditions applicable to the redemption request;
dynamically determine in real-time a plurality of gifting entities that are associated with the applicable conditions;
dynamically generate a menu display of one or more options corresponding to the plurality of gifting entities, wherein input corresponding to a selection is received regarding one of the displayed options; and
allocating one or more portions of the selected option across the plurality of gifting entities, wherein data regarding the selected option and the one or more allocated portions is routed to the plurality of gifting entities.

12. The system of claim 11, wherein the online gifting platform is associated with a set of available gifting entities, and wherein the determined plurality of gifting entities is identified from among the set of available gifting entities.

13. The system of claim 11, wherein the redemption request is associated with a user device, and wherein the processor further:
launches the online gifting platform based on the redemption request, wherein the launched online gifting platform establishes communication with the user device.

14. The system of claim 11, further comprising:
memory that stores data regarding the plurality of gifting entities, the stored data including one or more of the applicable conditions; and
wherein the processor further queries a user device associated with the redemption request based on the stored data, wherein the processor dynamically determines the plurality of gifting entities based on one or more query responses.

15. The system of claim 11, further comprising:
memory that stores branding content associated with the plurality of gifting entities; and
wherein the processor further generates one or more graphic user interfaces based on the stored branding content in response to the redemption request.

16. The system of claim 15, wherein different branding content is presented in response to a subsequent redemption request.

17. The system of claim 11, wherein a different menu display of options is dynamically generated in response to a subsequent redemption request.

18. The system of claim 11, wherein different conditions are dynamically determined to be applicable to a subsequent request.

19. The system of claim 11, wherein a different plurality of gifting entities is dynamically determined to be associated with a subsequent request.

20. The system of claim 11, wherein the communication interface further receives one or more personalization inputs associated with the selected option, wherein one of the personalization inputs identifies a third party recipient; and wherein the processor further generates a notification regarding the selection option, wherein the generated notification is provided to a device associated with the third party recipient.

21. A non-transitory, computer-readable storage medium having embodied thereon instructions executable by a computer system to perform a method, the method comprising:
receiving a redemption request associated with an online gifting platform;
dynamically determining one or more conditions applicable to the redemption request in real-time;
dynamically determining a plurality of gifting entities that are associated with the applicable conditions in real-time;
dynamically generating a menu display of options corresponding to the plurality of gifting entities;
receiving a selection regarding one of the displayed options;
allocating one or more portions of the selected option across the plurality of gifting entities; and
routing data regarding the selected option and the one or more allocated portions to the plurality of gifting entities.

22. The non-transitory, computer-readable storage medium of claim 21, wherein the online gifting platform is associated with a set of available gifting entities, and wherein the determined plurality of gifting entities is identified from among the set of available gifting entities.

23. The non-transitory, computer-readable storage medium of claim 21, wherein the redemption request is associated with a user device, and further comprising instructions executable to:
launch the online gifting platform based on the redemption request, wherein the launched online gifting platform establishes communication with the user device.

24. The non-transitory, computer-readable storage medium of claim 21, further comprising instructions executable to:
store data regarding the plurality of gifting entities, the stored data including one or more of the applicable conditions; and
query a user device associated with the redemption request based on the stored data, wherein dynamically determining the plurality of gifting entities is based on one or more query responses.

25. The non-transitory, computer-readable storage medium of claim 21, further comprising instructions executable to:
store branding content associated with the plurality of gifting entities; and
present the stored branding content on the online gifting platform in response to the redemption request.

26. The non-transitory, computer-readable storage medium of claim 25, wherein different branding content is presented in response to a subsequent redemption request.

27. The non-transitory, computer-readable storage medium of claim 21, wherein a different menu display of options is dynamically generated in response to a subsequent redemption request.

28. The non-transitory, computer-readable storage medium of claim 21, wherein different conditions are dynamically determined to be applicable to a subsequent request.

29. The non-transitory, computer-readable storage medium of claim 21, wherein a different plurality of gifting entities is dynamically determined to be associated with a subsequent request.

30. The non-transitory, computer-readable storage medium of claim 21, further comprising instructions executable to:
receive one or more personalization inputs associated with the selected option, wherein one of the personalization inputs identifies a third party recipient; and
generate a notification regarding the selection option, wherein the generated notification is provided to a device associated with the third party recipient.
